(19) United States
(12) Patent Application Publication
(10) Pub. No.: US 2006/0210711 A1
(43) Pub. Date: Sep. 21, 2006

(54) Processes for producing microcapsules

(75) Inventors: Masaki Hayashi, Okayama-shi (JP); Hidekazu Yoshizawa, Okayama-shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd.

(21) Appl. No.: 11/369,059

(22) Filed: Mar. 7, 2006

(30) Foreign Application Priority Data
Mar. 17, 2005 (JP) 077456/2005

(51) Int. Cl. B01J 13/02

(52) U.S. Cl. 427/213.3

(57) ABSTRACT

A process for producing a microcapsule comprises adding water to an liquid organic dispersion at a room temperature, wherein the liquid organic dispersion comprises a colorant particle, a hydrophobic organic solvent, and an aqueous solution containing a water-soluble resin having an acid value of 20 to 400 mgKOH/g and having been neutralized to a neutralization degree of 5 to 50 mol %, and emulsifying the resin through phase inversion to produce a capsule particle in an aqueous phase, wherein the capsule particle comprises a dispersion system containing the colorant particle and the organic solvent, and a wall comprising the resin and encapsulating the dispersion system. In the process, when the amount to be added of water at which a mixture of the resin solution and water becomes clouded by addition of water to the resin solution is given as Y parts by weight, the phase inversion emulsification step is conducted by adding 0.75Y to 1.25Y parts by weight of water relative to 1 part by weight of the solid content of the neutralized resin to the liquid organic dispersion. Thus obtained microcapsule has a small dispersivity of the particle size, a large thickness of the wall, and a high strength.

### FIELD OF THE INVENTION

The present invention relates to processes for producing microcapsules (or particles encapsulating ink) preferably usable in electrophoretically image-displayable apparatuses (or devices), and to microcapsules obtainable by the processes.

### BACKGROUND OF THE INVENTION

Microencapsulation techniques have been widely applied as one of means for enclosing (or sealing) various materials (or core materials) such as a dye, a perfume (aromatic or flavoring agent), a crystalline liquid, an enzyme, a catalyst, and an adhesive. The advantages of such techniques are in that the handleability of these core materials can be improved and that the functions of the core materials can be maintained or retained for a long period of time.

On the other hand, display techniques are utilized in a broad range from a displaying method for displaying an image or character information to a visualizing method using a mode such as a liquid crystal mode, a plasma emission mode, or an EL (electroluminescence) mode. In recent years, as various electronic apparatuses (or devices) are miniaturized due to rapid advance of semiconductor technology, there are increasing demands for the miniaturization, weight-saving, lower driving voltage, less electricity consumption to work, and thinner flat panel of display devices. As new display method for responding to these requirements, there are proposed electrophotetically image-displaying devices (or apparatuses) capable of writing images on the display surface by encapsulating microcapsules in a dispersed system (core material) in which electrophoretic particles (or electrophoretically-movable particles) are dispersed in a disperse medium, and interposing these microcapsules between electrode plates to migrate or move the electrophoretic particles in the microcapsules between these electrode plates by applying an electric field.

Japanese Patent Application Laid-Open No. 119264/1999 (JP-11-119264A) discloses a display device comprising a disperse system in which charged particles are dispersed into a disperse medium, a number of microcapsules encapsulating the disperse system, and a pair of opposed electrodes which are so disposed as to insert these microcapsules therebetween. In the display device, a given display operation is conducted by changing the distribution condition of the charged particles depending on an action of a controlled voltage to change the optical reflexivity. The particle size of the charged particles is about 1/1000 to ⅕ relative to that of the microcapsules, and the dispersivity in the particle size distribution of the charged particles (volume-average particle size/number-average particle size) is 1 to 2. Japanese Patent Application Laid-Open No. 202372/1999 (JP-11-202372A) discloses a display device comprising a disperse system comprising at least two kinds of charged particles encapsulated in the microcapsule, and a disperse medium containing a surfactant, wherein the charged particles contain at least one member of titanium oxide and carbon black.

Japanese Patent No. 2551783 discloses an electrophoretic display device using microcapsules encapsulating a disperse system, as microcapsules disposed between the electrodes, wherein the disperse system comprises a colored disperse medium, and at least one kind of an electrophoretic particle, dispersed in the medium, different in optical property from the medium. Further, Japanese Patent Application Laid-Open No. 503873/2001 (JP-2001-503873A) discloses an electrophoretically displaying device comprising an arrangement of discrete microscopic containers (or microcapsules); first and second electrodes disposed on and covering opposite sides of the arrangement, at least one of the electrodes being substantially visually transparent; a means for creating an electric potential difference between the two electrodes; and within each container, a suspension comprising a dielectric liquid and particles exhibiting surface charges in the dielectric liquid, wherein the dielectric liquid and the particles contracting visually, and the electric potential difference causing the particles to migrate toward one of the electrodes.

Moreover, Japanese Patent application Laid-Open No. 310050/2004 (JP-2004-310050A) discloses a microcapsule comprising a disperse system in which a colorant particle (e.g., titanium oxide) is dispersed in an oil phase, and a wall encapsulating the disperse system, wherein the wall is formed by a resin having an acid group or a salt thereof.

However, conventional microcapsules have low emulsion stability in an encapsulation process, and the particle size distribution shows polydispersity by division of oil droplets or unification of oil droplets. Therefore, it is necessary to subject the particles to classification treatment, thereby the yield is decreased. Moreover, a resin has a tendency to remain in an aqueous phase (or a water phase) without forming a wall, and the thickness of the wall becomes small. Therefore, the particle is easy to be broken by a shearing force due to stirring or other means. Further, the thickness of the wall cannot be improved enough, and thus obtained microcapsule is insufficient in strength.

### SUMMARY OF THE INVENTION

It is therefore an object of the present invention to provide a process for producing a microcapsule, in which efficient local distribution of a resin in an interface between an organic phase and an aqueous phase (or a water phase) ensures both improvement in encapsulation efficiency and increase in a wall thickness of the microcapsule; and to provide a microcapsule obtainable by the process.

Another object of the present invention is to provide a process for producing a microcapsule, in which stability of an emulsion is increased, dispersivity of a particle size is reduced, and strength of a capsule is improved; and to provide a microcapsule obtainable by the process.

The inventors of the present invention made intensive studies to achieve the above objects and finally found that, in a process for producing a microcapsule by phase inversion emulsification (or emulsification with phase inversion), phase inversion emulsification by addition of water in a specific proportion induces local distribution of a resin in an interface between an organic phase and an aqueous phase (or a water phase), and increase of wall thickness of the microcapsule. In addition, the inventors found that the process ensures to stabilize an emulsion, thereby reducing dispersivity in the particle size of the microcapsule. The present invention was accomplished based on the above findings.

That is, the present invention includes a process for producing a microcapsule, which comprises

adding water to an liquid organic dispersion at a room temperature,
wherein the liquid organic dispersion comprises a colorant particle, a hydrophobic organic solvent, and an aqueous solution containing a water-soluble resin having an acid value of 20 to 400 mgKOH/g and having been neutralized to a neutralization degree of 5 to 50 mol %, and

emulsifying the resin through phase inversion to produce a capsule particle in an aqueous phase (or a water phase),

wherein the capsule particle comprises a dispersion system containing the colorant particle and the organic solvent, and a wall comprising the resin and encapsulating the dispersion system; and

when the amount to be added of water at which a mixture of the resin solution and water becomes clouded (or becomes turbid in white) by addition of water is given as Y parts by weight, the phase inversion emulsification step is conducted by adding 0.75Y to 1.25Y parts by weight of water relative to 1 part by weight of the solid content of the neutralized resin to the liquid organic dispersion.

The amount Y (the amount to be added of water relative to 1 part by weight of the solid content of the resin) relative to the neutralization degree may be represented by the following linear expression (1):
Y=aX+b (1)

wherein X represents a neutralization degree (mol %), “a” and “b” are positive constant numbers, respectively, and Y has the same meaning as defined above.

As the neutralized resin, a resin having an acid value of about 50 to 300 mgKOH/g and having been neutralized to a neutralization degree of about 10 to 45 mol % may be used. The phase inversion emulsification step may be conducted by adding about 0.8Y to 1.2Y parts by weight of water relative to 1 part by weight of solid content of the neutralized resin to the liquid organic dispersion. The resin constituting the wall may have an acid group or a salt thereof, and the acid group or the salt thereof may be further crosslinked or cured (e.g., crosslinked or cured by a crosslinking agent).

The present invention also includes a microcapsule obtainable by the above-mentioned production process. Such a microcapsule has a large thickness of the wall and a small dispersivity of the particle size. In the microcapsule, for example, the mean particle size may be about 0.5 to 500 μm, the mean thickness of the wall may be about 0.05 to 5 μm, and the particle size distribution (CV) calculated from the following formula (2) based on the mean particle size of the microcapsule and the standard deviation of the particle size thereof may be not more than 40%:
CV (%)=(standard deviation of particle size/mean particle size)×100 (2)

In the microcapsule, the disperse system may comprise an electrically insulating dielectric liquid, and a single or a plurality of species of colorant particle(s) dispersed in the dielectric liquid, and the colorant particle may be charged in the disperse system (or oil phase) and movable electrophoretically in the microcapsule by an electric potential difference. The microcapsule is interposed between a pair of electrodes, and is useful for displaying an image by electrophoresis of the colorant particle.

### BRIEF DESCRIPTION OF THE DRAWINGS

FIG. 1 is a graph representing a relationship between a neutralization degree X and an amount Y of water to be added (an amount of water to be added relative to 1 part by weight of a solid content of a resin) in Examples 1 to 16.

### DETAILED DESCRIPTION OF THE INVENTION

The microcapsule of the present invention comprises a disperse system (or an oil phase disperse system) in which a colorant particle is dispersed in an oil phase, and a wall (or shell) which encapsulates (or encloses) the disperse system. The wall is usually formed from a resin such as an anionic resin (a resin having an acid group or a salt thereof).

(Resin)

The acid group of the anionic resin (or self-water dispersible resin) may include, for example, a carboxyl group, an acid anhydride group, a phosphoric acid group, a sulfonic acid group, and others. The anionic resin may have one species of the acid group, or may have two or more species of the acid groups in combination.

The anionic resin is not particularly limited to a specific one as far as an organic continuous phase containing the resin, produced by a neutralization treatment can be mixed with an aqueous medium (such as water and/or an aqueous organic solvent) to form a discontinuous phase in which the organic phase is dispersed in the aqueous continuous phase. Such a resin may be a condensation-series resin containing the acid group at a given concentration [for example, a polyester-series resin (e.g., an aliphatic polyester-series resin, an aromatic polyester-series resin, and a polyester-series elastomer), a polyamide-series resin, and a polyurethane-series resin], or a polymerization-series resin (or an addition condensation-series resin) [for example, an olefinic resin, a styrenic resin, and a (meth)acrylic resin]. Among these resins, the polymerization-series resin (or the addition condensation-series resin) is usually employed in many cases.

The typical polymerization-series resin having an acid group (or acid group-containing resin) may be obtained by polymerization of a polymerizable monomer having at least an acid group (or acidic polymerizable monomer), and may be usually obtained by copolymerization of an acidic polymerizable monomer and a polymerizable monomer (or acid group-free polymerizable monomer) which is copolymerizable to the acidic polymerizable monomer. If necessary, a monomer containing a crosslinkable functional group other than an acid group may be further copolymerized.

The typical examples of the acid group-containing polymerizable monomer may include a polymerizable carboxylic acid [e.g., a polymerizable monocarboxylic acid such as (meth)acrylic acid, or crotonic acid; a partial ester of a polymerizable polycarboxylic acid such as monobutyl itaconate, or monobutyl maleate (e.g., a monoC₁₋₁₀alkylester of a polymerizable dicarboxylic acid); and a polymerizable polycarboxylic acid or an anhydride thereof such as itaconic acid, maleic acid, fumaric acid, or maleic anhydride], a phosphoric acid group-containing monomer [for example, a phosphoxyC₂₋₆alkyl(meth)acrylate such as 2-phosphoxyethyl(meth)acrylate; and an acid phosphoxyalkyl(meth)acrylate (e.g., an acid phosphoxyC₂₋₆alkyl(meth)acrylate such as phosphoxy acid phosphoxyethyl(meth)acrylate)], a sulfonic acid group-containing polymerizable monomer [for example, 3-chloro-2-acrylamide-2-methylpropanesulfonic acid, and styrenesulfonic acid; and a sulfoalkyl(meth)acrylate (e.g., a sulfoC₂₋₆alkyl(meth)acrylate such as 2-sulfoethyl(meth)acrylate)]. These acid group-containing polymerizable monomers may be used singly or in combination. Among these monomers, a polymerizable monomer (particularly (meth)acrylic acid) having a carboxyl group, an acid anhydride group and/or a sulfonic acid group is preferred.

The amount of the acid group-containing polymerizable monomer may be usually about 3 to 80 mol %, preferably about 5 to 70 mol % (e.g., 10 to 60 mol %), and more preferably about 15 to 50 mol % (e.g., 20 to 40 mol %) relative to the total monomers.

The copolymerizable monomer may include, for example, an aromatic vinyl monomer [e.g., styrene, an alkylstyrene (e.g., a C₁₋₄alkylstyrene such as vinyltoluene), and chlorostyrene], an alkyl ester of (meth)acrylic acid [e.g., a linear or branched C₁₋₁₈alkyl (meth)acrylate, such as methyl (meth)acrylate, isopropyl (meth)acrylate, or t-butyl (meth)acrylate], a vinyl ester or a vinyl ester of an organic acid [e.g., a vinyl ester of a linear or branched C₂₋₂₀alipatic carboxylic acid, such as vinyl acetate, and a vinyl ester of an aromatic carboxylic acid, such as vinyl benzoate], a polymerizable nitrile or a vinylcyanide [e.g., (meth)acrylonitrile], an olefin [e.g., α-C₂₋₁₀olefin such as ethylene, propylene, or 1-butene], a halogen-containing monomer [e.g., a chlorine-containing monomer (such as vinyl chloride or vinylidene chloride), and a fluorine-containing vinyl monomer (e.g., a halogenated α-olefin such as vinyl fluoride, vinylidene fluoride, or tetrafluoroethylene, and a (meth)acrylate having a fluorine-containing alkyl group)], a monomer having ultraviolet absorbability or antioxidant property [e.g. a polymerizable monomer having a benzotriazole ring, such as 2-(2′-hydroxy-5-(meth)acryloyloxyethylphenyl)-2H-benzotriazole; a polymerizable monomer having a benzophenone backbone, such as 2-hydroxy-4-(2-(meth)acryloyloxyethoxy)benzophenone; a polymerizable monomer having 2,2,6,6-tetramethylpiperidyl group, such as 1,2,2,6,6-pentamethyl-4-piperidyl(meth)acrylate], a nitrogen-containing monomer [e.g., N-vinylpyrrolidone, and diacetone acrylamide], a macromonomer having one polymerizable unsaturated group in one terminal (or end) of the molecular, and others. These copolymerizable monomers may be used singly or in combination.

Among these copolymerizable monomers, a styrenic monomer (particularly styrene), and an alkyl ester of (meth)acrylic acid [in particular a C₁₋₁₂alkyl acrylate, a C₁₋₄alkyl methacrylate (e.g., methyl methacrylate)] are usually employed. Thus obtained copolymer may be a styrene-(meth)acrylate-(meth)acrylic acid-series copolymer.

The preferred anionic resin usually has a functional group participating in crosslinking or curing ((A1) a self-crosslinkable group, or (A2) a crosslinkable functional group to (i) a reactive group of a resin or (ii) a crosslinking agent). Such an anionic resin may be obtained by copolymerization of a polymerizable monomer having a functional group (a self-crosslinking group and/or a crosslinkable functional group) with the polymerizable monomer having the acid group and/or the copolymerizable monomer. Moreover, the acid group of the anionic resin may be utilized as a crosslinkable functional group, and such an anionic resin may be obtained by polymerization of the polymerizable monomer having the acid group, and optionally the copolymerizable monomer.

As the polymerizable monomer having the self-crosslinkable group, there may be mentioned a polymerizable monomer having a methylol group or an N-alkoxymethyl group [e.g., N-methylol(meth)acrylamide, and an N-alkoxymethyl(meth)acrylamide such as N-butoxymethyl(meth)acrylamide], a polymerizable monomer having a silyl group or an alkoxysilyl group [e.g., a C₁₋₂alkoxyvinylsilane such as dimethoxymethylvinylsilane, or trimethoxyvinylsilane; a (meth)acryloyloxyalkylC₁₋₂alkoxysilane such as 2-(meth)acryloyloxyethyldimethoxymethylsilane], and others.

Moreover, the crosslinkable functional group may be introduced into a resin by copolymerization of a polymerizable monomer having a functional group capable of forming a crosslinking system in relation to the species of the functional group introduced into the resin and/or the crosslinking agent to be used. Examples of the functional group constituting the crosslinking system may include a reactive group with respect to a carboxyl group or acid anhydride group (e.g., an epoxy group or glycidyl group, a hydroxyl group, a methylol group, and an N-alkoxymethyl group), a reactive group with respect to a hydroxyl group (e.g., a carboxyl group or acid anhydride group, an isocyanate group, a methylol group or N-alkoxymethyl group, a silyl group or alkoxysilyl group), and others. The crosslinkable functional group is composed of a carboxyl group, an acid anhydride group, a hydroxyl group, and/or a glycidyl group in many cases.

Regarding the crosslinking system-formable monomer, a polymerizable monomer having a carboxyl group or an acid anhydride group, and a polymerizable monomer having a methylol group, an N-alkoxymethyl group, a silyl group or an alkoxysilyl group are the same as mentioned above. As the polymerizable monomer containing an epoxy group or a glycidyl group, there may be exemplified glycidyl(meth)acrylate, allylglycidyl ether, and others. The polymerizable monomer containing a hydroxyl group may include an alkylene glycol mono(meth)acrylate [e.g., a C₂₋₈alkylene glycol (mono)methacrylate such as 2-hydroxyethyl (meth)acrylate], a (meth)acrylic monomer added thereto a lactone [e.g., “PLACCEL FM-2” and “PLACCEL FA-2”, each manufactured by Daicel Chemical Industries, Ltd.], a hydroxyl group-containing (meth)acrylate [e.g., a polyalkylene glycolmono(meth)acrylate such as diethylene glycol mono(meth)acrylate, a polyethylene glycol mono(meth)acrylate, or a polypropylene glycol mono(meth)acrylate], hydroxyethyl vinyl ether, hydroxybutyl vinyl ether, and others. The polymerizable monomer having an isocyanate group may include, for example, vinylphenylisocyanate.

The amount of the polymerizable monomer having a self-crosslinkable group or a crosslinkable functional group may be, for example, about 1 to 30 mol %, preferably about 3 to 25 mol %, and more preferably about 5 to 20 mol % relative to the total monomers.

The polymerization of the polymerizable monomer may be conducted by a conventional method, for example, a thermal polymerization, a solution polymerization, or a suspension polymerization, and is usually carried out by a solution polymerization which comprises polymerizing a monomer in a reaction solvent (organic solvent) in practical cases. The reaction solvent may include an inert solvent, for example, an aromatic hydrocarbon such as toluene, or xylene; an alicyclic hydrocarbon such as cyclohexane; an aliphatic hydrocarbon such as hexane; an alcohol such as methanol, ethanol, or 2-propanol (isopropanol, IPA); a ketone such as acetone, or methyl ethyl ketone; an ester such as ethyl acetate; an ether alcohol such as cellosolve, or carbitol; an ether ester such as butyl cellosolve acetate; and others. These solvents may be used singly or in combination as a mixed solvent. In the preferred embodiment, a readily removable solvent, e.g., a solvent having a low boiling point (for example, a solvent having a boiling point of about 70 to 120° C.) such as 2-propanol, acetone, methyl ethyl ketone, or ethyl acetate is used.

The polymerization of the polymerizable monomer may be conducted in the presence of a polymerization initiator. As the polymerization initiator, there may be exemplified a peroxide (e.g., a diacyl peroxide such as benzoyl peroxide, a dialkyl peroxide such as di-t-butyl peroxide, an alkyl hydroperoxide such as cumene hydroperoxide, methyl ethyl ketone peroxide, and t-butyl peroxy-2-ethylhexanoate), an azo-series compound (e.g., azobisisobutyronitrile), a persulfate salt, hydrogen peroxide, and others. The polymerization may be usually carried out at a temperature of about 50 to 150° C. under an inert atmosphere.

Regarding the molecular weight of the anionic resin, the number average molecular weight of the resin may be usually selected within a range from about 0.05×10⁴ to 10×10⁴, and preferably about 0.1×10⁴ to 5×10⁴ (e.g., about 0.2×10⁴ to 2×10⁴).

From the viewpoint of preventing the microcapsule from adhesion in the drying process or blocking under a high temperature, as well as the properties as a material for the electrophoretic display device, the resin preferably has high transparency, and is in a solid form at an ambient temperature at which the microcapsule is used, for example, at a temperature of not higher than 50° C. (e.g., a room temperature such as about 10 to 30° C.).

The concentration of the acid group of the water-dispersible resin may be selected from a range that a stable capsule particle can be formed by neutralizing at least part (usually, part) of the acid group with a base and dispersing the dispersed system into an aqueous medium (or an aqueous phase) with use of phase inversion emulsification. When the acid group is in a free form, the acid value of the resin may for example be about 20 to 400 mgKOH/g, preferably about 50 to 300 mgKOH/g, and more preferably about 100 to 250 mgKOH/g. Incidentally, the acid value means an amount (mg) of KOH necessary to neutralize 1 g of the resin (solid bases). If the acid value is too small, it is difficult to disperse the resin and form a capsule particle even when not less than 100 mol % of the acid group is neutralized with a base. On the other hand, the larger the acid value deteriorates the formation of stable particles in an aqueous medium.

Moreover, in order to inhibit volatilization or exudation (or leakage) of the oil phase (organic phase or organic solvent phase) of the encapsulated core material, the resin for forming the wall preferably has a barrier property against the oil phase of the core material (for example, a resin being insoluble against the oil phase or non-erodible by the oil phase). From such a viewpoint, the resin constituting the wall may be crosslinked or cured.

The glass transition temperature of the anionic resin may be, for example, selected from the range of about −25° C. to 200° C., preferably about 0 to 150° C. (e.g., about 25 to 120° C.), and more preferably about 50 to 120° C. (e.g., about 70 to 100° C.) depending on the ambient temperature of the microcapsule.

(Disperse System)

The disperse system (core material) encapsulated in the microcapsule comprises an oil phase (organic solvent phase or disperse medium), and a colorant particle dispersed in the oil phase. The colorant particle in the oil phase is usually charged with electricity, and can be migrated or moved electrophoretically in the microcapsule by an electric potential difference.

The oil phase is a liquid form at an ambient temperature at which the microcapsule is used (e.g., a room temperature such as about 10 to 30° C.), and the oil phase may usually comprise a hydrophobic liquid (hydrophobic organic solvent), in particular an electrically insulating dielectric liquid (e.g., a solvent having a volume resistivity of not less than 10¹⁰Ω and a dielectric constant of not less than 2.5).

As the disperse medium (or organic solvent (phase)) of the core material, there may be exemplified an electric insulative solvent having high electric resistance, for example, a hydrocarbon [e.g., an aromatic hydrocarbon such as benzene-series, toluene-series, or naphthene-series hydrocarbon; an alicyclic hydrocarbon such as cyclohexane; an aliphatic hydrocarbon such as hexane, kerosene, a linear or branched paraffinic hydrocarbon, or trade name “ISOPAR” (manufactured by Exxon Mobil Corporation); and an alkylnaphthalene], a diphenyl-diphenyl ether mixture, a halogen-containing solvent [for example, a halogenated hydrocarbon (e.g., hydrocarbon tetrachloride), a fluorine-containing solvent (e.g., a chlorofluorocarbon such as CHFC-123 or HCFC-141b; a fluoroalcohol; a fluorine-containing ether such as a fluoroether; a fluorine-containing ester such as a fluoroester; and a fluoroketone)], and a silicone oil [e.g., a silicone oil such as a poly(dimethylsiloxane)]. These solvents may be used singly or in combination.

The organic disperse medium of the core material has a higher boiling point than that of an organic solvent (for example, a reaction solvent to be used for polymerization of a polymerizable monomer) of a resin solution to be subjected to phase inversion emulsification and is advantageously selected from a high-boiling organic solvent which can remain as the disperse medium for the coloring agent in the capsules even after removing the solvent from the resin solution.

As the colorant particle of the disperse system (a coloring agent or a movable colorant particle), various colorant particles (achromatic or chromatic particles) may be utilized, and may be, for example, a particle different in optical properties from the disperse medium, a particle causing visual contrast by electrophoresis, a particle formable a visually recognizable pattern in the visible region directly or indirectly, and other colorant particles. For example, there may be mentioned a colorant particle such as an inorganic pigment (e.g., a black pigment such as carbon black, a white pigment such as titanium dioxide, zinc oxide or zinc sulfide, a red pigment such as iron oxide, a yellow pigment such as yellow iron oxide (FeO(OH)) or cadmium yellow, and a blue pigment such as Berlin blue (or iron blue) or ultramarine blue), an organic pigment (e.g., a yellow pigment such as pigment yellow or Diarylide yellow, an orangish pigment such as pigment orange, a red pigment such as pigment red, lake red or pigment violet, a blue pigment such as copper phthalocyanine blue or pigment blue, and a green pigment such as copper phthalocyanine green), a resin particle colored with a coloring agent (e.g., a dye, and a pigment). These colorant particles may be used singly or in combination. That is, in the disperse system, single (or the same kind (or class) or the same category or series) colorant particles may be dispersed in the disperse medium (e.g., an electrically insulating dielectric liquid), or a plurality species of colorant particles (or colorant particles having different colors) may be dispersed in the disperse medium. Incidentally, the colorant particle may have a functional group (or a reactive group), for example, on the surface thereof, and examples of the functional group (or the reactive group) may include a hydroxyl group, a carboxyl group, a sulfonic acid group, an amino group, and an imino group. Among the colorant particles, an inorganic pigment (particularly a metal oxide-series pigment such as titanium dioxide, zinc oxide, or iron oxide), and/or an organic pigment is preferred.

The mean particle size or particle diameter of the colorant particle (coloring agent) may be selected from the range of about 0.01 to 1 μm, and may be on the nanometer length scale [e.g., about 10 to 500 nm, preferably about 20 to 500 nm, (e.g., about 30 to 400 nm), and more preferably about 50 to 300 nm]. The colorant particle (coloring agent) may have a particle size in a nanometer order (e.g., about 20 to 100 nm) which is transparent to visible light. The particle size distribution of the colorant particle (coloring agent) is not particularly limited to a specific one, and a colorant particle having narrow particle size distribution (e.g., monodisperse particle) is preferred.

The content of the colorant particle in the core material may be in such a range that electrophoretical movability is not adversely affected, and the content may for example be about 1 to 70% by weight (e.g., about 1 to 60% by weight), preferably about 1 to 50% by weight, and more preferably about 1 to 40% by weight (e.g., about 1 to 20% by weight).

Incidentally, the disperse medium may be colored with various dyes (e.g., an oil soluble dye such as an anthraquinone or an azo compound) as far as the disperse medium produces the contrast in relation to the colorant particle. For example, the disperse medium may be colored with a different color from the colorant particle.

Incidentally, in order to inhibit aggregation of the colorant particle (or movable particle) and improve dispersion stability, the disperse system may comprise a viscosity controller, as well as various components for controlling the polarity or surface charge amount of the colorant particle, for example, a surface-treating agent (e.g., a resin having a polar group) for coating or covering on the surface of the colorant particle or adhering or bonding to the surface thereof, a dispersing agent (e.g., a dispersion stabilizer, and a surfactant), a charge-controlling agent, and others.

The microcapsule is usually in a spherical form (including a fine spherical form). The mean particle size of the microcapsule may be selected from the range of about 1 to 1000 μm. The mean particle size of the microcapsule may be usually about 5 to 500 μm, preferably about 10 to 300 μm, and more preferably about 15 to 100 μm.

In the present invention, the particle size distribution of the microcapsule is not particularly limited to a specific one, usually exhibits a normal distribution, and the breadth of the distribution is preferably narrow (for example, monodisperse form). In the microcapsule, the particle size distribution (CV) calculated from the following formula based on the mean particle size and the standard deviation of the particle size is, for example, not more than 40% (e.g., about 1 to 35%), preferably not more than 30% (e.g., about 5 to 28%), and more preferably not more than 25% (e.g., about 10 to 23%).
CV (%)=(standard deviation of particle size/mean particle size)×100 (2)

Incidentally, the microcapsule usually has a high light-transmittance, and may for example have a visible light transmittance of not less than 80% (e.g., about 80 to 100%).

Moreover, the mean wall thickness of the microcapsule may be, for example, about 0.05 to 5 μm, preferably about 0.2 to 3 μm, and more preferably about 0.25 to 2.5 μm (e.g., about 0.3 to 2 μm).

Such a microcapsule is useful for displaying an image (such as a character or a pattern) by interposing the microcapsule between a pair of electrodes constituting a display device (e.g., a pair of electrodes in which at least the electrode of the display side comprises a transparent electrode), and electrophoretically moving the colorant particle in the microcapsule by applying a voltage to the electrodes (electromotive force). In the image display, the pair of electrodes may be changed or alternated in polarity in order to control a moving direction of the colorant particle.

For example, in the case of using a microcapsule encapsulating a disperse system (core material) which comprises a colored disperse medium and a dispersed colorant particle producing a contrast with respect to the disperse medium (e.g., a particle different in optical properties from the disperse medium, or a colorant particle different in color from the disperse medium), the disperse system shows or exhibits the color of the disperse medium in a normal condition (or state), and displays a pattern caused by the colorant particle by electrophoretically moving the colorant particle toward the display surface side in response of an action of an electric field. For instance, use of a disperse system comprising a disperse medium colored with a black dye and a white particle dispersed therein can display or exhibit a white pattern by electrophoretic movement of the white particle. Moreover, in a disperse system comprising a disperse medium colored with a yellow dye and a blue particle dispersed in the colored medium, a blue pattern can be displayed by electrophoretic movement of the blue particle.

Moreover, use of a microcapsule encapsulating (or including) a disperse system (core material) in which a single colorant particle (e.g., a white particle, a black particle) is dispersed ensures to display an image pattern on a display surface by electrophoresis of the colorant particle. Moreover, a color pattern can be displayed or exhibited by optionally using a color filter in combination with the colorant particle.

Further, a microcapsule encapsulating a disperse system (core material) in which a yellow particle (particularly, a particle of nanometer order) is dispersed in a medium (a yellow microcapsule), a microcapsule encapsulating a disperse system (core material) in which a red particle (particularly, a particle of nanometer order) is dispersed in a medium (a red microcapsule), a microcapsule encapsulating a disperse system (core material) in which a blue particle (particularly, a particle of nanometer order) is dispersed in a medium (a blue microcapsule), and optionally a microcapsule encapsulating a disperse system in which a black particle (particularly, a particle of nanometer order) is dispersed in a medium (a black microcapsule) are prepared. Each of the colored microcapsules is interposed between a pair of electrodes, in the form of a layer structure, and a full-color pattern can be displayed or exhibited in response to controlling the voltage applied to each electrode or the polarity of the electrodes, by utilizing a subtractive mixture. Incidentally, if necessary, a color filter may be interposed between each layers.

Furthermore, an action of an electric field to each pixel which comprises a yellow pixel comprising a yellow microcapsule, a red pixel comprising a red microcapsule, and a blue pixel comprising a blue microcapsule ensures display of a full-color image. Incidentally, if necessary, a black pixel comprising a black microcapsule or a white pixel comprising a white microcapsule may be disposed between the electrodes.

Moreover, when a plurality of colorant particles (or disperse system) which are charged with different electric charge (+ or −) from each other in the disperse medium are utilized, the movement of the plurality of colorant particles in the reverse direction from each other can be realized by applying a voltage between opposed (faced) electrodes, and the moving direction of the plurality of colorant particles can be controlled by switching (or controlling) the polarity of the applied voltage. For example, in the case of using a microcapsule in which negatively charged titanium oxide and positively charged carbon black are dispersed in the disperse medium, a bright-colored image (faded color pattern) can be formed with titanium oxide by making the polarity of the electrodes of the display surface side positive, and also, a black image can be formed with carbon black by making the polarity of the electrodes of the display surface side negative.

The microcapsule may be produced by adding water to a mixture (or an liquid organic dispersion) containing a resin whose acid group has been partly neutralized, a colorant particle, and an organic solvent at a room temperature, emulsifying the resin through phase inversion of the organic phase and the aqueous phase (or the water phase) to produce a capsule particle in the aqueous phase (or the water phase), wherein the capsule particle comprises a dispersion system (a core material) containing the colorant particle and the organic solvent, and a wall comprising the resin and encapsulating the dispersion system. In the present invention, particularly, as the resin whose acid group has been neutralized, a resin obtained by neutralizing a resin, having an acid value of 20 to 400 mgKOH/g, up to a neutralization degree of 5 to 50 mol % is used, and for phase inversion emulsification, water is added in a specific proportion. Incidentally, the formed capsule particle may be separated from the water phase, and further, if necessary, may be dried. Moreover, after production of the capsule particle, the resin constituting the wall may be crosslinked or cured. The crosslinking or curing of the wall may be conducted in a suitable stage, for example, a step for drying the capsule particle, or conducted in the aqueous medium after production of the capsule particle.

(Preparation of Liquid Organic Dispersion)

In a preparation of the liquid organic dispersion constituting the disperse system, the order of mixing or dispersing the anionic resin, the colorant particle and the organic solvent is not particularly limited to a specific one, and for example, (1) the colorant particle may be mixed and dispersed in the organic solvent solution of the anionic resin (e.g., an aqueous solution of a water-soluble resin), (2) an aqueous solution of the water-soluble anionic resin, the colorant particle and the organic solvent may be mixed to prepare a liquid dispersion, and (3) a liquid dispersion (or a coloring agent dispersed in oil phase) in which the colorant particle is dispersed in the organic solvent, and an aqueous solution of the water-soluble anionic resin may be mixed. Incidentally, in such a method, the acid group of the anionic resin may be subjected to neutralization treatment before preparation of the liquid organic dispersion, or during preparation of the liquid organic dispersion.

For neutralization of the water-dispersible resin, various bases may be used, and may include, for example, an inorganic base [e.g., ammonia, and an alkali metal hydroxide such as sodium hydroxide or potassium hydroxide], and an organic base [e.g., an alkylamine such as trimethylamine, triethylamine or tributylamine (particularly a trialkylamine), an amino alcohol (e.g., a linear chain amino alcohol such as 2-(dimethylamino)ethanol, 2-(methylamino)ethanol, 3-dimethylamino-1-propanol, or 3-methylamino-1-propanol; and a branched chain amino alcohol such as 1-dimethylamino-2-propanol, 2-dimethylamino-2-methyl-1-propanol, or 3-dimethylamino-2,2-dimethyl-1-propanol), and a heterocyclic amine such as morpholine]. These bases may be used singly or in combination.

The neutralization degree for the acid group of the resin may be selected from the range of about 5 to 50 mol %, and may be usually about 10 to 45 mol %, and preferably about 10 to 40 mol %. In the case where the neutralization degree is too high, there is a possibility that addition of water to the liquid organic dispersion does not cause clouding depending on the size of the acid value of the resin, or that efficient phase inversion cannot be realized. Moreover, when the neutralization degree is too low, it becomes difficult to form the capsule particle depending on the acid value of the resin.

Along with preparing the liquid organic dispersion, the colorant particle (or coloring agent) may be used in the form of a liquid dispersion in which the colorant particle is pre-dispersed with an appropriate dispersing agent (e.g., a low or high molecular weight dispersing agent, a surfactant). Moreover, the dispersing treatment of the colorant particle (coloring agent) may be conducted by utilizing a conventional means for dispersion, for example, an ultrasonication apparatus, a ball mill, and others.

More specifically, the step for preparing the liquid organic dispersion may for example be conducted as follows. A resin solution (an aqueous solution of a water-soluble resin) is obtained by preparing an organic solvent solution (e.g., an aqueous organic solvent solution) containing a resin having an appropriate acid value based on carboxyl group, and neutralizing the acid group of the resin with a base to a suitable neutralization degree. On the other hand, a liquid dispersion containing a colorant particle is prepared by dispersing a colorant particle, and if necessary a crosslinking agent (a crosslinking agent reactive to a carboxyl group, e.g., an epoxy resin) in a hydrophobic solvent. Then, the liquid dispersion and the resin solution (the aqueous solution of the water-soluble resin) is mixed together to prepare a liquid organic dispersion in which the coloring agent is dispersed in the organic solvent solution containing the resin, the crosslinking agent, and others.

(Production of Capsule Particle)

In the formation step of the capsule particle, water (e.g., distilled water, and ion exchanged water) is added to the liquid organic dispersion (coloring agent dispersed in oil phase) in which the colorant particle is dispersed in the organic solvent, the organic phase and the water phase are phase-inverted to form an organic dispersion phase (organic phase) in an aqueous continuous phase (water phase), and a capsule particle having a core material encapsulated (or enclosed) in the anionic resin is formed from thus obtained water dispersion which is in the state of dispersing the organic phase in the water phase. Incidentally, in the phase inversion emulsification, when water is added to an organic continuous phase containing a resin whose acid group has been neutralized, an organic solvent, and others, the continuous phase is changed or transformed from the organic continuous phase (O-phase) to the aqueous continuous phase (W-phase), the organic phase becomes a discontinuous phase by emulsification of the resin (that is, phase inversion emulsification occurs), thereby the resin is localized around the organic phase to form a capsule particle enclosing the organic phase, and obtain a water dispersion in which the capsule particle is stably dispersed in the water medium.

The phase inversion emulsification may be usually conducted with acting a shearing force (e.g., a shearing force such as agitation, and vibrational shearing force such as a supersonic wave) on the mixed system comprising the liquid organic dispersion and water.

The proportion of water to be added to the organic phase is important from the viewpoint of stabilizing water-disperse system (emulsion) and efficiently localizing the resin in the interface between the organic phase and the water phase. In the present invention, when the amount to be added of water at which the resin solution (usually, the aqueous solution of the water-soluble resin) becomes clouded along with addition of water is given as Y parts by weight, the phase inversion emulsification is conducted by adding about 0.75Y to 1.25Y parts by weight of water relative to 1 part by weight of the solid content of the resin to the liquid organic dispersion.

The amount Y of water is an amount of water to be added relative to 1 part by weight of the solid content of the resin, and may be represented by the following linear expression (1) for the neutralization degree X.
Y=aX+b (1)

In the formula, X represents a neutralization degree (mol %), “a” and “b” are positive constant numbers, respectively, and Y has the same meaning as defined above.

The constant numbers “a” and “b” may be calculated by measuring the point (the amount Y of water to be added) at which the solution becomes clouded by adding water to an organic solvent solution (e.g., 2-propanol solution) of the anionic resin beforehand (the aqueous solution of the water-soluble resin), and repeating the following steps several times: varying the neutralization degree X of the resin, and measuring the clouded point (or cloud point) of the solution in the same matter. Incidentally, in the present specification, the clouded point is defined as the amount of water to be added at which the haze value becomes 15% in measuring the turbidity of a mixture containing the organic solvent solution (the aqueous solution of the water-soluble resin) and water. Incidentally, the haze value of the organic solvent solution is about 0 to 10%. Moreover, the organic solvent (aqueous organic solvent) constituting the organic solvent solution is not particularly limited to a specific one as long as the solvent is capable of dissolving an anionic resin. For example, as the organic solvent, a solvent similar to the reaction solvent for the above-mentioned polymerization reaction, for example, an alcohol such as 2-propanol, a ketone such as acetone, a cellosolve, and others may be used.

The ranges of the constant numbers “a” and “b” are not particularly limited to a specific one. For example, the number “a” may be selected from the range over 0 to not more than 10 (e.g., about 0.01 to 5). The number “b” may be selected from the range over 0 to not more than 50 (e.g., about 1 to 40).

In the phase inversion emulsification, the amount of water to be added (the amount of water phase inversion) relative to 1 part by weight of the solid content of the resin is preferably about 0.8Y to 1.2Y parts by weight, more preferably about 0.85Y to 1.15Y parts by weight, and particularly about 0.9Y to 1.1Y parts by weight. In the case where the amount of water phase inversion is too small, a large amount of the anionic resin remains in the aqueous continuous phase, and the amount of the anionic resin existing as an emulsifier on the surface of the oil droplet is small. Therefore, the capsule wall cannot be grown sufficiently. Moreover, in the case where the amount of water phase inversion is too large, the polarity of the aqueous continuous phase becomes high, and therefore the anionic resin comes short of hydrophilicity resulting in precipitating easily. As a result, the anionic resin existing as an emulsifier on the surface of the oil droplet becomes insufficient, and the capsule wall cannot be grown enough. Thus, since too large or too small amount of water phase inversion brings about insufficient growing of the capsule wall, the capsule wall is low in strength and is easily broken due to shearing by agitation. Moreover, since the particle size distribution of the capsule particle also becomes polydispersity, it is necessary to classify the particle for any purpose, and as a result, the yield of the desired particle is decreased. According to the present invention, as mentioned above, the formability of the capsule particle wall, the thickness of the wall, and the physical properties of the wall can be controlled by setting the amount of water phase inversion to a specific range.

The phase inversion emulsification (containing the determination of the constant numbers “a” and “b”) is carried out at a room temperature (e.g., about 10 to 30° C.), and preferably about 15 to 25° C. Moreover, in the phase inversion emulsification, the temperature difference between the liquid organic dispersion and water is preferably small, and the temperature difference between the two may be usually about 0 to 15° C. (preferably about 0 to 10° C., and particularly about 0 to 5° C.).

Incidentally, the emulsification mixture produced by the phase inversion emulsification comprises a microcapsule particle encapsulating the disperse system, and a disperse medium (solvent phase) dispersing the microcapsule particle therein. The solvent phase contains water and an organic solvent [an organic solvent (e.g., a polymerization solvent) other than a hydrophobic disperse medium of a coloring agent which is encapsulated in a capsule particle and comprises a disperse system]. Therefore, the emulsification mixture produced by phase inversion emulsification may be usually subjected to a treatment for removing an organic solvent (removal processing of an organic solvent) [for example, a conventional method such as distillation (particularly, distillation under reduced pressure)] to give a liquid aqueous dispersion in which a microcapsule particle is dispersed in an aqueous medium. To the liquid aqueous dispersion may be added or supplemented an aqueous medium (e.g., water), if necessary.

(Crosslinking or Curing of Wall)

The crosslinking or curing of the capsule particle may be conducted by crosslinking or curing the resin constituting the wall (usually, the acid of the resin or a salt thereof) by self-crosslinking or with a crosslinking agent. The crosslinking or curing of the wall increases the thickness of the wall and enhances the mechanical strength of the capsule particle, as well as improves barrier property to the oil phase.

The crosslinking agent usually has a plurality of reactive groups in one molecule, and may be selected depending on the species of the crosslinkable functional group of the resin, and for example, the following combinations may be used.

(1) When the crosslinkable functional group is a carboxyl group, examples of the crosslinking agent may include an aminoplast resin (for example, a resin having a methylol group or an alkoxymethyl group such as a urea resin, a guanamine resin, or a melamine resin), a glycidyl group-containing compound (or a polyepoxy compound or an epoxy resin), a carbodiimide group-containing compound (a polycarbodiimide compound), an oxazoline group-containing compound [for example, a polyoxazoline compound such as a polymer having an oxazoline group (e.g., an acrylic polymer, and an acryl-styrenic copolymer)] a metal chelate compound, and others.

(2) When the crosslinkable functional group is a hydroxyl group, the crosslinking agent may include, for example, an aminoplast resin, a polyisocyanate compound which may be blocked, an alkoxysilane compound, and others.

(3) When the crosslinkable functional group is a glycidyl group, examples of the crosslinking agent may include a carboxyl group-containing compound (a polycarboxylic acid or an acid anhydride thereof), a polyamine compound, a polyaminoamide compound, a polymercapto compound, and others.

(4) When the crosslinkable functional group is an amino group, the crosslinking agent may include a carboxyl group-containing compound (a polycarboxylic acid or an anhydride thereof), a polyisocyanate compound which may be blocked, a glycidyl group-containing compound (or a polyepoxy resin, or an epoxy resin), and others.

Among the crosslinking agents, the polyepoxy compound (also including an epoxy resin) may include a glycidyl ether-based epoxy compound [for example, a glycidyl ether compound obtained by a reaction of a polyhydroxy compound (e.g., a bisphenol compound, a polyhydric phenol compound, an alicyclic polyhydric alcohol compound, and an aliphatic polyhydric alcohol compound) and epichlorohydrin, and a novolak epoxy resin], a glycidyl ester-based epoxy compound (for example, a polycarboxylic acid polyglycidyl ester, e.g., a diglycidyl ester of an aromatic dicarboxylic acid such as phthalic acid or terephthalic acid; a diglycidyl ester of an alicyclic dicarboxylic acid such as tetrahydrophthalic acid or dimethylhexahydrophthalic acid; and a diglycidyl ester of a dimer acid, or a modified product thereof), a glycidyl amine-based epoxy compound [for example, a reaction product of an amine compound and epichlorohydrin, e.g., an N-glycidyl aromatic amine {e.g., tetraglycidyl diaminodiphenylmethane (TGDDM), triglycidyl aminophenol (such as TGPAP or TGMAP), diglycidyl aniline (DGA), diglycidyl toluidine (DGT), tetraglycidyl xylylenediamine (e.g., TGMXA)}, and an N-glycidyl alicyclic amine (e.g., tetraglycidyl bisaminocyclohexane)], in addition, a cyclic aliphatic epoxy resin (e.g., an alicyclic diepoxy acetal, an alicyclic diepoxyadipate, an alicyclic diepoxycarboxylate, and a vinylcyclohexane dioxide), a heterocyclic epoxy resin (e.g., triglycidyl isocyanurate (TGIC), and a hydantoin-based epoxy resin), and others.

The glycidyl ether-based epoxy compound may include, depending on the species of the polyhydroxy compound, for example, a glycidyl ether of a bisphenol compound [for example, a diglycidyl ether of a bisphenol compound (e.g., a bis(hydroxyphenyl)alkane such as 4,4′-dihydroxybiphenyl, bisphenol A), such as a bisphenol-based epoxy resin such as a bisphenol A diglycidyl ether (a bisphenol A-based epoxy resin); a diglycidyl ether of a C₂₋₃alkylene oxide adduct to a bisphenol compound], a glycidyl ether of a polyhydric phenol compound (e.g., a diglycidyl ether of resorcin, or hydroquinone), a glycidyl ether of an alicyclic polyhydric alcohol compound (e.g., diglycidyl ether of cyclohexanediol, cyclohexanedimethanol, or hydrogenerated bisphenol compound), a glycidyl ether of an aliphatic polyhydric alcohol compound (e.g., a diglycidyl ether of an alkylene glycol such as ethylene glycol or propylene glycol; a polyoxyC₂₋₄alkylene glycol diglycidyl ether such as a polyethylene glycol diglycidyl ether), a novolak epoxy resin (e.g., a phenol-novolak or cresol-novolak epoxy resin), and others. The bisphenol A-based epoxy compound is, for example, available from Japan Epoxy Resins Co., Ltd. as “Epikote™ 828”. Moreover, trade name “EPICLON 850” (manufactured by Dainippon Ink And Chemicals, Inc.) as bifunctional glycidyl ether, trade name “TECHMORE™” (manufactured by Mitsui Chemicals, Inc.) as a trifunctional glycidyl ether, and trade name “TETRAD-X” from Mitsubishi Gas Chemical Company, Inc. as a tetrafunctional glycidyl group are also commercially available.

Among the crosslinking agents, the carbodiimide group-containing compound may include, for example, a dialkylcarbodiimide (e.g., a diC₁₋₁₀alkylcarbodiimide such as diethylcarbodiimide, or dipropylcarbodiimide); a dicycloalkylcarbodiimide (e.g., a diC₃-10 cycloalkylcarbodiimide such as dicyclohexylcarbodiimide); an arylcarbodiimide (e.g., di-p-tolylcarbodiimide, an arylpolycarbodiimide such as triisopropylbenzenepolycarbodiimide); and others.

As the polyisocyanate compound, there may be mentioned a diisocyanate compound [e.g., an aliphatic diisocyanate such as hexamethylene diisocyanate (HMDI) or 2,2,4-trimethylhexamethylene diisocyanate; an alicyclic diisocyanate such as isophorone diisocyanate (IPDI); an aromatic diisocyanate such as tolylene diisocyanate (TDI), or diphenylmethane-4,4′-diisocyanate (MDI); an araliphatic diisocyanate such as xylylene diisocyanate], a triisocyanate compound (e.g., an aliphatic triisocyanate such as lysine ester triisocyanate, or 1,3,6-triisocyanatohexane; an alicyclic triisocyanate such as 1,3,5-triisocyanatocyclohexane; an aromatic triisocyanate such as triphenylmethane-4,4′,4″-triisocyanate), and a tetraisocyanate compound (e.g., 4,4′-diphenylmethane-2,2′,5,5′-tetraisocyanate). The polyisocyanate compound may be a block isocyanate which is blocked or masked with phenol, alcohol, caprolactam or others.

The polycarboxylic acid may include a dicarboxylic acid (e.g., an aliphatic dicarboxylic acid such as adipic acid; an alicyclic dicarboxylic acid such as hexahydrophthalic acid; an aromatic dicarboxylic acid such as phthalic acid or terephthalic acid), a tricarboxylic acid such as trimellitic acid, a tetracarboxylic acid such as pyromellitic acid, or others. The acid anhydride of the polycarboxylic acid also includes an anhydride of the above-mentioned polycarboxylic acid, dodecenylsuccinic acid anhydride, methyltetrahydrophthalic acid anhydride, phthalic acid anhydride, HET acid anhydride, or others.

Examples of the polyamine compound may include a hydrazine compound (e.g., hydrazine, a dihydrazide of an organic acid), analiphaticpolyamine (e.g., a C₂₋₁₀alkylene diamine such as ethylene diamine, trimethylene diamine, or hexamethylene diamine; diethylene triamine, triethylene tetramine, tetraethylene pentamine, and pentaethylene hexamine), an alicyclic polyamine (e.g., diaminocyclohexane, menthene diamine, isophorone diamine, di(aminomethyl)cyclohexane, bis (4-aminocyclohexyl)methane, and bis(4-amino-3-methylcyclohexyl)methane), an aromatic polyamine [e.g., a C₆₋₁₀arylene diamine such as phenylene diamine or diaminotoluene; xylylene diamine, di(2-amino-2-propyl)benzene; 4,4′-biphenylene diamine, biphenylenebis(4-aminophenyl)methane, bis-(4-amino-3-chlorophenyl)methane], or others.

The polyoxazoline compound may include an acryl-styrenic copolymer having an oxazoline group [for example, “EPOCROS (registered trademark) K series” manufactured by Nippon Shokubai Co., Ltd.], an acrylic polymer having an oxazoline group [for example, “EPOCROS (registered trademark) WS series” manufactured by Nippon Shokubai Co., Ltd.], “NK Linker NX” manufactured by Shin-nakamura Chemical Corporation, and others.

The crosslinking agents may be used singly or in combination. Among combinations of the crosslinkable functional group and the crosslinking agent, the preferred combination includes (a) a combination of a carboxyl group and a carbodiimide group-containing compound (polycarbodiimide compound); (b) a combination of a carboxyl group and a polyepoxy compound or an epoxy resin; (c) a combination of a carboxyl group and an oxazoline compound; and (d) a combination of a hydroxyl group or an amino group and a polyisocyanate compound; and other combinations.

The crosslinking agent is preferably a compound dissolved in either the oil phase or the water phase, and is also preferably a crosslinking agent having an imparted hydrophilicity (a hydrophilic or water-soluble crosslinking agent). For example, the carbodiimide compound having an imparted hydrophilicity is available as a hydrophilic carbodilite (“V-02”, “V-02-L2”, and “V-04”, each manufactured by Nisshinbo Industries, Inc.), and others. Moreover, as a carbodiimide compound having lipophilicity, a lipophilic carbodilite (“V-05” and “V-07”, each manufactured by Nisshinbo Industries, Inc.), or others is commercially available.

The proportion of the resin having the crosslinkable functional group relative to the crosslinking agent is not particularly limited to a specific ratio, and the ratio of the reactive group of the crosslinking agent (such as a carbodiimide group and epoxy group) relative to 1 equivalent of the crosslinkable functional group (such as a carboxyl group) may be selected from the range of about 0.1 to 2 equivalent, preferably about 0.1 to 1.2 equivalent, and more preferably about 0.2 to 1 equivalent (e.g., about 0.3 to 0.9 equivalent).

The crosslinking agent may be contained in at least one phase of an oil phase (liquid organic dispersion) and a water phase (water), and the timing of addition is not particularly limited to a specific time. For example, the crosslinking agent may be added to a liquid organic dispersion obtained in the step for preparing the liquid organic dispersion, or may be added to an organic solvent in advance of the preparation of the liquid organic dispersion. Moreover, the crosslinking agent may be added to an emulsified dispersion (liquid aqueous dispersion) obtained by the phase inversion emulsification, or to a liquid aqueous dispersion in which the organic solvent has been eliminated from the emulsified dispersion. In the case of using the hydrophobic or oil-soluble crosslinking agent, it is usually advantageous that the crosslinking agent is added to an organic phase. When the hydrophilic or water-soluble crosslinking agent is used, it is advantageous that the crosslinking agent is added to a water phase. In the preferred embodiment, the wall of the capsule particle may be crosslinked or cured in the water phase by adding the crosslinking agent to the liquid dispersion containing the coloring agent in advance of mixing with the resin solution, and heat-treating a mixture obtained by the phase inversion emulsification. If necessary, a hydrophobic or oil-soluble crosslinking agent and a hydrophilic or water-soluble crosslinking agent may be added in a suitable step to react the crosslinkable functional group of the resin component with the crosslinking agent. Further, if necessary, the crosslinking agent may be used in combination with catalyst(s) (e.g., an acid catalyst, and a basic catalyst).

The crosslinking or curing of the resin may be conducted at a suitable temperature, and may be usually conducted by heating with stirring. Incidentally, the crosslinking or curing is often carried out in the presence of an aqueous solvent or a hydrophobic solvent. Therefore, the crosslinking or curing is usually carried out, with stirring the liquid dispersion, at a temperature not higher than a boiling point of the solvent (preferably water), for example, at a temperature of about 50 to 100° C., preferably about 50 to 90° C., and more preferably about 50 to 80° C. In order to inhibit adhesion or agglomeration of the microcapsule particles, the crosslinking or curing may be carried out at a temperature below the glass transition temperature of the wall (or the resin).

(Crosslinking or Curing of Residual Crosslinking Agent)

After the resin constituting the wall is crosslinked or cured with a crosslinking agent, the residual crosslinking agent may be further crosslinked or cured with a polyfunctional compound to increase the crosslinking degree of the wall. The crosslinking or curing with the polyfunctional compound ensures to further increase the thickness of the wall and to further enhance the mechanical strength of the microcapsule.

Such a polyfunctional compound has a plurality of functional groups crosslinkable or curable with a crosslinkable group of the crosslinking agent, and preferably has relatively low molecular weight.

The polyfunctional compound may be selected depending on the crosslinkable group of the crosslinking agent, and may include, for example, the following compounds:

(1) in the case where the crosslinkable group is a glycidyl group (epoxy group); a polycarboxylic acid or an anhydride thereof, and/or a polyamine compound,

(2) in the case where the crosslinkable group is a methylol group or an alkoxymethyl group; a polycarboxylic acid or an anhydride thereof, and/or a polyhydroxy compound,

(3) in the case where the crosslinkable group is a carbodiimide group, an oxazoline group, or a metal chelate; a polycarboxylic acid or an anhydride thereof,

(4) in the case where the crosslinkable group is a silyl group or an alkoxysilyl group; a polyhydroxy compound, (5) in the case where the crosslinkable group is an isocyanate group; a polyhydroxy compound, and/or a polyamine compound,

(6) in the case where the crosslinkable group is a carboxyl group; a polyhydroxy compound, a polyepoxy compound, and/or a polyamine compound,

(7) in the case where the crosslinkable group is an amino group; a polycarboxylic acid or an anhydride thereof, a polyepoxy compound, and/or a polyisocyanate compound, and

(8) in the case where the crosslinkable group is a mercapto group; a polyepoxy compound.

Among the polyfunctional compounds, examples of the polyhydroxy compound may include a diol compound [e.g., an aliphatic diol such as an alkylene glycol (e.g., ethylene glycol), or a polyoxyalkylene glycol (e.g., diethylene glycol); an alicyclic diol such as 1,4-cyclohexanediol, 1,4-cyclohexanedimethanol, or a hydrogenated bisphenol A; and an aromatic diol or an alkylene oxide adduct thereof, such as hydroquinone, biphenol, 2,2-bis(4-hydroxyphenyl)propane, or xylylene glycol], a triol compound (e.g., glycerin, trimethylolpropane, and trimethylolethane), a tetraol compound (e.g., pentaerythritol), or others.

As the polyepoxy compound, there may be mentioned a compound having relatively lower molecular weight among the above-mentioned epoxy compounds, for example, a glycidyl ether of a polyhydroxy compound such as a polyhydric phenol compound, an alicyclic polyhydric alcohol compound, or an aliphatic polyhydric alcohol compound; a polyglycidyl ester of a polycarboxylic acid; an N-glycidyl aromatic amine; an N-glycidyl alicyclic amine; and others. The polycarboxylic acid, the polyisocyanate compound, and the polyamine compound may include a compound exemplified in the paragraph of the crosslinking agent.

These polyfunctional compounds may be used singly or in combination.

The proportion of the polyfunctional compound relative to the crosslinkable group of the residual crosslinking agent is not particularly limited to a specific one. For example, the proportion may be selected from about 0.1 to 2 equivalent of the functional group of the polyfunctional compound (e.g., an amino group of a polyamine compound) relative to 1 equivalent of the crosslinkable group (e.g., glycidyl group), and may be usually selected from about 0.1 to 1.2 equivalent, preferably about 0.2 to 1 equivalent, and more preferably about 0.3 to 0.9 equivalent of the functional group of the polyfunctional compound relative to 1 equivalent of the crosslinkable group (e.g., glycidyl group).

The timing of addition of the polyfunctional compound is not particularly limited to a specific one, and the polyfunctional compound may be added after crosslinking or curing the wall of the capsule particle with the crosslinking agent.

(Separation and Drying of Capsule Particle)

The capsule particle may be separated from the water phase through a conventional method (such as filtration or centrifugation) to make a wet cake of the capsule particles, and if necessary, dried through a conventional method (such as spray drying or lyophilization). Moreover, the capsule particle may be separated by drying the liquid aqueous dispersion containing the capsule particle through a conventional drying method (such as spray drying or lyophilization). The powdery microcapsule (capsule type display element or ink) enclosing the disperse system (oil disperse system or core material) may be obtained by drying the capsule particle. Incidentally, the capsule particle may be subjected to hydrolyzing treatment with an acid to liberate the neutralized acid group of the resin before separation or drying or after drying.

According to the present invention, phase inversion emulsification by addition of water in a specific proportion efficiently induces local distribution of a resin in an interface between an organic phase and a water phase, and increase in wall thickness of a microcapsule, and therefore, improves the capsule strength. In addition, according to the present invention, an emulsion can be stabilized efficiently, thereby dispersivity in the particle size of the microcapsule is reduced.

The microcapsules of the present invention are, for example, useful for an image display device (or element) for forming an image by utilizing an electrophoresis of a colorant particle in response to applying a voltage between electrodes.

### EXAMPLES

The following examples are intended to describe this invention in further detail and should by no means be interpreted as defining the scope of the invention.

### Example 1

(i) Preparation and Neutralization of Anionic Resin

In a reaction vessel, 120 parts of 2-propanol (IPA) was put, and heated to 80° C. Then, to IPA was added dropwise a mixture, containing the following components in a proportion shown below, in the reaction vessel over 2 hours under a nitrogen flow, and the reaction was carried out.

| | | |
|---|---|---|
| Methyl methacrylate (MMA) | 50 | parts by weight |
| Butyl acrylate (BA) | 25 | parts by weight |
| Methacrylic acid (MAA) | 25 | parts by weight |
| 2,2′-azobis-2,4′-dimethylvaleronitrile | 1.5 | parts by weight |
| (ADVN) | | |

Two hours after completion of the dropwise of the above mixture, to the reaction mixture was added a mixture of IPA (20 parts by weight) and ADVN (1 part by weight) over 2 hours. The resulting reaction mixture was maintained at 80° C. for another 3 hours to give a resin solution containing a solid content (or heating residue or nonvolatile content) of 41.7%. The acid value of the resulting resin was 162.9 mgKOH/g.

To 24.0 parts by weight of the above-mentioned resin solution (solid content: 10 parts by weight) was added 76.0 parts by weight of IPA at a room temperature, and 0.44 part by weight of dimethylaminoethanol as a neutralizing agent was added thereto for neutralization treatment (neutralization degree of 15 mol %). Incidentally, the solid content of the neutralized resin solution is 10% by weight.

(ii) Preparation of Colored Pigment Liquid Dispersion

Diisopropylnaphthalene (manufactured by Kureha Chemical Industry Co., Ltd., “KMC-113”), oil blue, and a pigment-dispersing agent (manufactured by Avecia KK, “Solsperse 17000”) were mixed in the following proportion under heating with stirring. After dissolving Diisopropylnaphthalene thoroughly at 90° C., the mixture was maintained for 20 minutes, and then cooled to a room temperature. In the resulting colored solution (oil blue solution dissolved in diisopropylnaphthalene) was dispersed titanium oxide (manufactured by Tayca Corporation, “JR-405”) in the following proportion to prepare a titanium oxide dispersion.

| | | |
|---|---|---|
| Diisopropylnaphthalene | 50 | parts by weight |
| Oil blue | 1 | part by weight |
| Pigment-dispersing agent | 0.5 | part by weight |
| Titanium oxide | 5 | parts by weight |

To 55.6 parts of the resulting titanium oxide dispersion was added 3.9 parts of an epoxy resin (manufactured by Mitsubishi Gas Chemical Company, Inc., “TETRAD-X”). The mixture was stirred at a room temperature for 10 minutes to prepare a titanium oxide dispersion containing the epoxy resin.

(iii) Preparation of Coloring Agent Dispersion Emulsion by Phase Inversion Emulsification

100.4 parts by weight of the neutralized resin solution obtained from the step (i) (solid content: 10 parts by weight) and 59.5 parts by weight of the epoxy resin-containing titanium oxide dispersion obtained from the step (ii) were mixed at a room temperature, and ion exchanged water was added dropwise to the mixture under stirring for phase inversion emulsification. Incidentally, the amount (W) of the dropwise ion exchanged water was determined as 142.8 parts by weight in accordance with the following formula.
Y=W/R=0.164X+11.82
Y=W/10=0.164×15+11.82
Y=14.28 (W=142.8) (3)

In the formula, W represents an amount of ion exchanged water (parts by weight), and R represents a weight (solid content) of a neutralized resin solution (parts by weight). X and Y have the same meanings as defined above.

(iv) Preparation of Encapsulated Ink

The emulsion obtained by phase inversion emulsification in the step (iii) was subjected to the following post-treatment step to give a powdery microcapsule.

That is, the emulsion was heat-treated at 80° C. for 30 minutes, and an epoxy resin (manufactured by Mitsubishi Gas Chemical Company, Inc., “TETRAD-X”) and a carboxyl group of the resin constituting the emulsion were crosslinked. The resulting mixture was distilled under a reduced pressure to remove IPA, and a liquid aqueous dispersion was obtained. To the liquid aqueous dispersion was added 300 parts by weight of deionized water, and the mixture was further heat-treated at 80° C. overnight to complete the crosslinking between the epoxy group of the epoxy resin and the carboxyl group of the resin. To the reaction mixture was added 6.1 parts by weight of diethylenetriamine as a hardening agent for the epoxy resin, and the epoxy group of the epoxy resin remaining within the capsule was allowed to react with diethylenetriamine at the interface between oil and water to consume the residual epoxy group thoroughly. The reaction mixture was filtered to separate a cake, 300 parts of deionized water was added to the cake, and the mixture was adjusted to pH 2 to 3 with acetic acid with stirring, and dried by a spray drier to give a capsule powder. The mean particle size of the obtained capsule was 63 μm. Moreover, the glass transition temperature (Tg) of the wall was 198° C.

### Example 2

In neutralization of the anionic resin, a capsule powder was prepared in the same manner as Example 1 except that the amount of dimethylaminoethanol as a neutralizing agent was 0.94 part by weight (neutralization degree: 25 mol %) and that the amount W of ion exchanged water used for phase inversion emulsification was changed to 159.2 parts by weight in accordance with the above-mentioned formula (3).

### Example 3

In neutralization of the anionic resin, a capsule powder was prepared in the same manner as Example 1 except that the amount of dimethylaminoethanol as a neutralizing agent was 1.31 parts by weight (neutralization degree: 35 mol %) and that the amount W of ion exchanged water used for phase inversion emulsification was changed to 175.6 parts by weight in accordance with the above-mentioned formula (3).

### Comparative Example 1

A capsule powder was prepared in the same manner as Example 1 except that the amount of ion exchanged water used for phase inversion emulsification was changed to 102.8 parts by weight. Incidentally, the amount of water to be added relative to 1 part by weight of the resin is 10.28 parts by weight, and corresponds to 0.72Y1 when the amount of water to be added in Example 1 is considered as Y1.

### Comparative Example 2

A capsule powder was prepared in the same manner as Example 2 except that the amount of ion exchanged water used for phase inversion emulsification was changed to 203.8 parts by weight. Incidentally, the amount of water to be added relative to 1 part by weight of the resin is 20.38 parts by weight, and corresponds to 1.28Y2 when the amount of water to be added in Example 2 is considered as Y2.

### Example 4

(i) Preparation and Neutralization of Anionic Resin, and Preparation of Coloring Pigment Dispersion

In neutralization of the anionic resin, a neutralized resin solution having a neutralization degree of 15 mol % was prepared in the same manner as Example 1 except that the resin solution, IPA and dimethylaminoethanol were used in the following proportions, respectively. In addition, a coloring agent dispersion was prepared in the same manner as Example 1. Incidentally, the solid content of thus obtained neutralized resin solution was 14.9%.

| | |
|---|---|
| Resin solution | 36.0 parts by weight |
| | (solid content: 15 parts by weight) |
| IPA | 64.0 parts by weight |
| Dimethylaminoethanol | 0.66 part by weight |

(ii) Preparation of Coloring Agent Dispersion Emulsion by Phase Inversion Emulsification

A phase inversion emulsification was carried out in the same manner as Example 1 except that the proportion of the neutralized resin solution was 100.7 parts by weight and that the proportion W of ion exchanged water used for phase inversion emulsification was changed to 133.3 parts by weight in accordance with the following formula (4).
Y=W/R=0.0707X+7.8244 (4)

In the formula, X, Y, Wand R have the same meanings as defined above.

(iii) Preparation of Encapsulated Ink

A powdery microcapsule was obtained in the same manner as Example 1 except for using the emulsion obtained by phase inversion emulsification in the above step (ii).

### Example 5

In neutralization of the anionic resin, a capsule powder was prepared in the same manner as Example 4 except that the amount of dimethylaminoethanol as a neutralizing agent was 1.40 parts by weight (neutralization degree: 25 mol %) and that the amount W of ion exchanged water used for phase inversion emulsification was changed to 143.9 parts by weight in accordance with the above-mentioned formula (4).

### Example 6

A capsule powder was prepared in the same manner as Example 5 except that the amount W of ion exchanged water used for phase inversion emulsification was changed to 115.1 parts by weight. Incidentally, the amount of water to be added relative to 1 part by weight of the resin is 7.673 parts by weight, and corresponds to 0.80Y5 when the amount of water to be added in Example 5 is considered as Y5.

### Example 7

A capsule powder was prepared in the same manner as Example 5 except that the amount W of ion exchanged water used for phase inversion emulsification was changed to 179.8 parts by weight. Incidentally, the amount of water to be added relative to 1 part by weight of the resin is 11.987 parts by weight, and corresponds to 1.25Y5 when the amount of water to be added in Example 5 is considered as Y5.

### Example 8

In neutralization of the anionic resin, a capsule powder was prepared in the same manner as Example 4 except that the amount of dimethylaminoethanol as a neutralizing agent was 1.96 parts by weight (neutralization degree: 35 mol %) and that the amount W of ion exchanged water used for phase inversion emulsification was changed to 154.5 parts by weight in accordance with the above-mentioned formula (4).

### Comparative Example 3

A capsule powder was prepared in the same manner as Example 5 except that the amount of ion exchanged water used for phase inversion emulsification was changed to 105.0 parts by weight. Incidentally, the amount of water to be added relative to 1 part by weight of the resin is 7 parts by weight, and corresponds to 0.70Y5 when the amount of water to be added in Example 5 is considered as Y5.

### Comparative Example 4

A capsule powder was prepared in the same manner as Example 6 except that the amount of ion exchanged water used for phase inversion emulsification was changed to 200.8 parts by weight. Incidentally, the amount of water to be added relative to 1 part by weight of the resin is 13.389 parts by weight, and corresponds to 1.30Y6 when the amount of water to be added in Example 6 is considered as Y6.

### Example 9

(i) Preparation and Neutralization of Anionic Resin, and Preparation of Coloring Pigment Dispersion

In neutralization of the anionic resin, a neutralized resin solution having a neutralization degree of 15 mol % was prepared in the same manner as Example 1 except that the resin solution, IPA and dimethylaminoethanol were used in the following proportions, respectively. In addition, a coloring agent dispersion was prepared in the same manner as Example 1. Incidentally, the solid content of thus obtained neutralized resin solution was 19.8%.

| | |
|---|---|
| Resin solution | 48.0 parts by weight |
| | (solid content: 20 parts by weight) |
| IPA | 52.0 parts by weight |
| Dimethylaminoethanol | 0.88 part by weight |

(ii) Preparation of Coloring Agent Dispersion Emulsion by Phase Inversion Emulsification

A phase inversion emulsification was carried out in the same manner as Example 1 except that the proportion of the neutralized resin solution was 100.9 parts by weight and that the proportion W of ion exchanged water used for phase inversion emulsification was changed to 116.7 parts by weight in accordance with the following formula (5).
Y=W/R=0.0738X+4.7286 (5)

In the formula, X, Y, W and R have the same meanings as defined above.

(iii) Preparation of Encapsulated Ink

A powdery microcapsule was obtained in the same manner as Example 1 except for using the emulsion obtained by phase inversion emulsification in the above step (ii).

### Example 10

In neutralization of the anionic resin, a capsule powder was prepared in the same manner as Example 9 except that the amount of dimethylaminoethanol as a neutralizing agent was 1.87 parts by weight (neutralization degree: 25 mol %) and that the amount W of ion exchanged water used for phase inversion emulsification was changed to 131.5 parts by weight in accordance with the above-mentioned formula (5).

### Example 11

A capsule powder was prepared in the same manner as Example 10 except that the amount W of ion exchanged water used for phase inversion emulsification was changed to 98.6 parts by weight. Incidentally, the amount of water to be added relative to 1 part by weight of the resin is 4.930 parts by weight, and corresponds to 0.75Y8 when the amount of water to be added in Example 10 is considered as Y8.

### Example 12

A capsule powder was prepared in the same manner as Example 10 except that the amount W of ion exchanged water used for phase inversion emulsification was changed to 157.8 parts by weight. Incidentally, the amount of water to be added relative to 1 part by weight of the resin is 7.890 parts by weight, and corresponds to 1.20Y8 when the amount of water to be added in Example 10 is considered as Y8.

### Example 13

In neutralization of the anionic resin, a capsule powder was prepared in the same manner as Example 9 except that the amount of dimethylaminoethanol as a neutralizing agent was 2.62 parts by weight (neutralization degree: 35 mol %) and that the amount of ion exchanged water used for phase inversion emulsification was changed to 146.2 parts by weight in accordance with the above-mentioned formula (5).

### Comparative Example 5

A capsule powder was prepared in the same manner as Example 10 except that the amount of ion exchanged water used for phase inversion emulsification was changed to 96.0 parts by weight. Incidentally, the amount of water to be added relative to 1 part by weight of the resin is 4.800 parts by weight, and corresponds to 0.73Y8 when the amount of water to be added in Example 10 is considered as Y8.

### Comparative Example 6

A capsule powder was prepared in the same manner as Example 10 except that the amount of ion exchanged water used for phase inversion emulsification was changed to 177.5 parts by weight. Incidentally, the amount of water to be added relative to 1 part by weight of the resin is 8.875 parts by weight, and corresponds to 1.35Y8 when the amount of water to be added in Example 10 is considered as Y8.

### Example 14

(i) Preparation and Neutralization of Anionic Resin, and Preparation of Coloring Pigment Dispersion

In neutralization of the anionic resin, a neutralized resin solution having a neutralization degree of 15 mol % was prepared in the same manner as Example 1 except that the resin solution, IPA and dimethylaminoethanol were used in the following proportions, respectively. In addition, a coloring agent dispersion was prepared in the same manner as Example 1. Incidentally, the solid content of thus obtained neutralized resin solution was 24.7%.

| | |
|---|---|
| Resin solution | 60.0 parts by weight |
| | (solid content: 25 parts by weight) |
| IPA | 40.0 parts by weight |
| Dimethylaminoethanol | 1.10 parts by weight |

(ii) Preparation of Coloring Agent Dispersion Emulsion by Phase Inversion Emulsification

A phase inversion emulsification was carried out in the same manner as Example 1 except that the proportion of the neutralized resin solution was 101.1 parts by weight and that the proportion W of ion exchanged water used for phase inversion emulsification was changed to 105.4 parts by weight in accordance with the following formula (6).
Y=W/R=0.0456X+3.532 (6)

In the formula, X, Y, W and R have the same meanings as defined above.

(iii) Preparation of Encapsulated Ink

A powdery microcapsule was obtained in the same manner as Example 1 except for using the emulsion obtained by phase inversion emulsification in the above step (ii).

### Example 15

In neutralization of the anionic resin, a capsule powder was prepared in the same manner as Example 14 except that the amount of dimethylaminoethanol as a neutralizing agent was 1.83 parts by weight (neutralization degree: 25 mol %) and that the amount W of ion exchanged water used for phase inversion emulsification was changed to 116.8 parts by weight in accordance with the above-mentioned formula (6).

### Example 16

In neutralization of the anionic resin, a capsule powder was prepared in the same manner as Example 14 except that the amount of dimethylaminoethanol as a neutralizing agent was 2.56 parts by weight (neutralization degree: 35 mol %) and that the amount W of ion exchanged water used for phase inversion emulsification was changed to 128.2 parts by weight in accordance with the above-mentioned formula (6).

### Comparative Example 7

A capsule powder was prepared in the same manner as Example 14 except that the amount of ion exchanged water used for phase inversion emulsification was changed to 137.0 parts by weight. Incidentally, the amount of water to be added relative to 1 part by weight of the resin is 5.480 parts by weight, and corresponds to 1.30Y10 when the amount of water to be added in Example 14 is considered as Y10.

### Comparative Example 8

A capsule powder was prepared in the same manner as Example 16 except that the amount of ion exchanged water used for phase inversion emulsification was changed to 89.7 parts by weight. Incidentally, the amount of water to be added relative to 1 part by weight of the resin is 3.588 parts by weight, and corresponds to 0.70Y12 when the amount of water to be added in Example 16 is considered as Y12.

Regarding capsule particles obtained in Examples and Comparative Examples, the states and properties of the capsule particle were evaluated as follows.

(1) Mean Particle Size and Particle Size Distribution of Capsule Particle

A capsule dispersion before drying by a spray-dryer was picked up with the use of a dropper. One droplet of the dispersion was dropped on a slide glass and covered with a cover glass (thickness: 0.17 mm). A photograph of the capsule particle was taken by an optical microscope (manufactured by Olympus Optical Co., Ltd. “Power BX51-33MD”), and the states of agglutination, destruction, and others were observed.

Further, On the basis of the taken optical micrograph, the mean particle size of the capsule particle was calculated by using an image analysis soft (“WinROOF”, manufactured by Mitani Corporation). Moreover, the particle size distribution was determined as a CV value, which shows dispersivity of particle size, in accordance with the following formula (2).
CV value (%)=(standard deviation/mean particle size)×100 (2)

(2) Thickness of Capsule Wall

Regarding each of Examples and Comparative Examples, an appropriate amount of hexane was placed in a beaker, and a capsule powder obtained from Examples or Comparative Examples was put in hexane. The beaker was set in an ultrasonic bath, and the capsule particle was broken by using a spatula with applying an ultrasonic wave to let out a core oil from the particle. The obtained dispersion was subjected to centrifugal sedimentation, and the precipitated broken capsule was separated. The broken capsule was put into fresh hexane under stirring. The centrifugal sedimentation and putting into fresh hexane were further repeated twice to wash the broken capsule. Finally, the broken capsule separated by the centrifugal sedimentation was dried on a filter paper at a room temperature for 2 days under an atmospheric air. The resulting dried matter was observed by a field emission scanning electron microscope (manufactured by Hitachi High-Technologies Corporation, “S-4700”), and the thickness of the capsule wall was measured based on the image of the fractured part of the wall.

(3) Relationship Between Neutralization Degree X and Optimized Amount of Water Phase Inversion (Y)

In the formula (3), the slope, 0.164 (corresponding to “a” in the formula (1)), and the intercept, 11.82 (corresponding to “b” in the formula (1)), of the straight line were determined as follows.

A given amount of dimethylaminoethanol as a neutralizing agent was added to the IPA solution of the anionic resin (solid content: 10% by weight) obtained from the step (i) of Example 1 under stirring to neutralize the resin. To the resulting resin solution was gradually added ion exchanged water while stirring continuously, and an amount Y of ion exchanged water at which the solution become clouded due to precipitation of the resin (an amount of water to be added relative to 1 part by weight of the solid content of the resin), that is, an optimized amount of water phase inversion, was measured as integrated amount. Incidentally, the cloudiness of the solution was evaluated from the turbidity (haze value) of the mixture containing the resin solution and ion exchanged water measured by means of a hazemeter (manufactured by Nippon Denshoku Industries Co., Ltd., “NDH 2000”). Incidentally, it was assumed that the cloudiness started at the time the haze value become 15%. The same operation was performed by changing the neutralization degree, and the amount Y of water to be added relative to each neutralization degree X was determined. From each X and Y, the slope “a” and the intercept “b” were calculated.

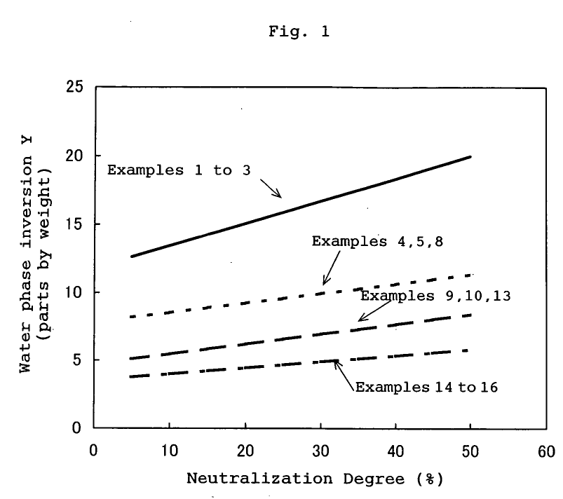

Incidentally, also in the formulae (4) to (6), the slope and the intercept were calculated in the same manner as described above. Regarding the formulae (3) to (6), the experimentally determined relationship between the neutralization degree X and the amount Y of water [=W/R (that is, the amount of water to be added relative to 1 part by weight of the solid content of the resin)] is shown in FIG. 1. Moreover, Tables 1 and 2 show the preparation conditions of the capsule particle, and the characteristics of the capsule particle.

TABLE 1

| | | Preparation conditions of | | | | | | |
|---|---|---|---|---|---|---|---|---|
| | | the capsule | | | Capsule characteristics | | | |
| | | | | Water | Mean wall | Mean | CV value | |
| | | Amount of resin | Neutralization | phase inversion | thickness | particle | of particle | |
| | | (parts by weight) | degree (mol %) | (parts by weight) | (nm) | size (μm) | size (%) | Remarks |
| Ex. | 1 | 10 | 15 | Y1 = 14.28 | 345 | 63 | 22.5 | |
| | 2 | 10 | 25 | Y2 = 15.92 | 543 | 55 | 20.8 | |
| | 3 | 10 | 35 | Y3 = 17.56 | 429 | 49 | 23.2 | |
| Com. Ex. | 1 | 10 | 15 | 0.72Y1 | 78 | 61 | 45.6 | Large amount of |
| | | | | | | | | broken capsule |
| | 2 | 10 | 25 | 1.28Y2 | 80 | 57 | 50.2 | Large amount of |
| | | | | | | | | broken capsule |
| Ex. | 4 | 15 | 15 | Y4 = 8.89 | 533 | 52 | 20.9 | |
| | 5 | 15 | 25 | Y5 = 9.59 | 874 | 48 | 21.4 | |
| | 6 | 15 | 25 | 0.80Y5 | 805 | 51 | 23.8 | |
| | 7 | 15 | 25 | 1.25Y5 | 825 | 49 | 24.1 | |
| | 8 | 15 | 35 | Y6 = 10.3 | 633 | 43 | 19.9 | |
| Com. Ex. | 3 | 15 | 25 | 0.70Y5 | 124 | 50 | 39.6 | Large amount of |
| | | | | | | | | broken capsule |
| | 4 | 15 | 35 | 1.30Y6 | 115 | 47 | 42.3 | Large amount of |
| | | | | | | | | broken capsule |

In the Table, the water phase inversion represents the amount (parts by weight) of water to be added relative to 1 part by weight the solid content of the neutralized resin.

TABLE 2

| | | Preparation conditions of | | | | | | |
|---|---|---|---|---|---|---|---|---|
| | | the capsule | | | Capsule characteristics | | | |
| | | | | Water | Mean wall | Mean | CV value | |
| | | Amount of resin | Neutralization | phase inversion | thickness | particle | of particle | |
| | | (parts by weight) | degree (mol %) | (parts by weight) | (nm) | size (μm) | size (%) | Remarks |
| Ex. | 9 | 20 | 15 | Y7 = 5.84 | 767 | 43 | 19.2 | |
| | 10 | 20 | 25 | Y8 = 6.58 | 1509 | 41 | 18.4 | |
| | 11 | 20 | 25 | 0.75Y8 | 1201 | 39 | 19.9 | |
| | 12 | 20 | 25 | 1.20Y8 | 1157 | 43 | 21.2 | |
| | 13 | 20 | 35 | Y9 = 7.31 | 982 | 35 | 17.7 | |
| Com. Ex. | 5 | 20 | 25 | 0.73Y8 | 189 | 44 | 56.1 | |
| | 6 | 20 | 25 | 1.35Y8 | 170 | 39 | 38.6 | |
| Ex. | 14 | 25 | 15 | Y10 = 4.22 | 996 | 33 | 17.1 | |
| | 15 | 25 | 25 | Y11 = 4.67 | 1720 | 28 | 16.6 | |
| | 16 | 25 | 35 | Y12 = 5.13 | 1232 | 20 | 16.2 | |
| Com. Ex. | 7 | 25 | 15 | 1.30Y10 | 225 | 22 | 35.8 | Large amount of |
| | | | | | | | | broken capsule |
| | 8 | 25 | 35 | 0.70Y12 | 199 | 23 | 38.2 | Large amount of |
| | | | | | | | | broken capsule |

In the Table, the water phase inversion represents the amount (parts by weight) of water to be added relative to 1 part by weight the solid content of the neutralized resin.

What is claimed is:

1. A process for producing a microcapsule, which comprises
adding water to an liquid organic dispersion at a room temperature,
wherein the liquid organic dispersion comprises a colorant particle, a hydrophobic organic solvent, and an aqueous solution containing a water-soluble resin having an acid value of 20 to 400 mgKOH/g and having been neutralized to a neutralization degree of 5 to 50 mol %, and
emulsifying the resin through phase inversion to produce a capsule particle in an aqueous phase,
wherein the capsule particle comprises a dispersion system containing the colorant particle and the organic solvent, and a wall comprising the resin and encapsulating the dispersion system; and
when the amount to be added of water at which a mixture of the resin solution and water becomes clouded by addition of water is given as Y parts by weight, the phase inversion emulsification step is conducted by adding 0.75Y to 1.25Y parts by weight of water relative to 1 part by weight of the solid content of the neutralized resin to the liquid organic dispersion.

2. A process according to claim 1, wherein the amount Y relative to the neutralization degree is represented by the following linear expression (1):
Y=aX+b (1)
wherein X represents a neutralization degree (mol %), “a” and “b” are positive constant numbers, respectively, and Y has the same meaning as defined above.

3. A process according to claim 1, wherein, as the neutralized resin, a resin having an acid value of 50 to 300 mgKOH/g and having been neutralized to a neutralization degree of 10 to 45 mol % is used.

4. A process according to claim 1, wherein the phase inversion emulsification step is conducted by adding 0.8Y to 1.2Y parts by weight of water relative to 1 part by weight of solid content of the neutralized resin to the liquid organic dispersion.

5. A process according to claim 1, wherein the resin constituting the wall has an acid group or a salt thereof, and the acid group or the salt thereof is further crosslinked or cured.

6. A process according to claim 1, wherein the resin comprising the wall has an acid group or a salt thereof, and the acid group or the salt thereof is further crosslinked or cured by a crosslinking agent.

7. A microcapsule obtainable by the process recited in claim 1.

8. A microcapsule according to claim 7, wherein the mean particle size of the microcapsule is 0.5 to 500 μm, the mean thickness of the wall is 0.05 to 5 μm, and the particle size distribution (CV) calculated from the following formula (2) based on the mean particle size of the microcapsule and the standard deviation of the particle size thereof is not more than 40%:
CV (%)=(standard deviation of particle size/mean particle size)×100 (2)

9. A microcapsule according to claim 7, wherein the disperse system comprises an electrically insulating dielectric liquid, and a single or a plurality of species of colorant particle(s) dispersed in the dielectric liquid, and the colorant particle is charged in the disperse system and movable electrophoretically in the microcapsule by an electric potential difference.

10. A microcapsule according to claim 7, which is interposed between a pair of electrodes, for displaying an image by electrophoresis of the colorant particle.
